(19) United States
(12) Patent Application Publication
(10) Pub. No.: US 2026/0004475 A1
(43) Pub. Date: Jan. 1, 2026

(54) IMAGE PROCESSING METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Cheng ZHU, Shenzhen (CN); Ke YAN, Shenzhen (CN)

(73) Assignee: Tencent Technology (Shenzhen) Company Limited, Shenzhen (CN)

(21) Appl. No.: 19/318,052

(22) Filed: Sep. 3, 2025

Related U.S. Application Data
(63) Continuation of application No. PCT/CN2023/138302, filed on Dec. 13, 2023.

(30) Foreign Application Priority Data
Jul. 20, 2023 (CN) 202310894097.4

(51) Int. Cl. G06T 11/00; G06T 5/70; G06T 9/00; G06V 10/44

(52) U.S. Cl. CPC G06T 11/00; G06T 5/70; G06T 9/00; G06V 10/44

(57) ABSTRACT

Embodiments of this application disclose an image processing method and apparatus, a device, and a medium. The method includes: obtaining a target image to be processed; inputting the target image to a pre-trained image-text model, a model loss of the image-text model including an image loss, and the image loss being constructed according to a first sample image and a second sample image that is obtained by converting a first sample text configured for describing the first sample image; and obtaining a target text configured for describing the target image and generated by the image-text model. In technical solutions of the embodiments of this application, the generated target text can describe the target image as accurately as possible, thereby ensuring accuracy of the target text.

### RELATED APPLICATION

This present application is a continuation of and claims the benefit of priority to PCT Application No. PCT/CN2023/138302, filed Dec. 13, 2023, and entitled IMAGE PROCESSING METHOD AND APPARATUS, DEVICE, MEDIUM AND PROGRAM PRODUCT, which is based on and claims the benefit of priority to Chinese Patent Application No. 202310894097.4, filed with the China National Intellectual Property Administration on Jul. 20, 2023, and entitled “IMAGE PROCESSING METHOD AND APPARATUS, DEVICE, AND MEDIUM”, which is incorporated herein by reference in its entirety. The above applications are incorporated herein by reference in their entireties.

### FIELD OF THE TECHNOLOGY

This application relates to the field of video and image processing technologies, and specifically, to image processing.

### BACKGROUND OF THE DISCLOSURE

In the field of images, common basic methods for generating an image description text include a question-answer form and a picture-based description form. However, a description text generated in the question-answer form tends to have problems of excessive simplification or omission of key information, causing a large difference between the description text and original image content. In addition, a description text generated in the picture-based description form is apt to be interfered with by irrelevant or secondary content in an image, which also causes a large difference between the generated text and image content.

### SUMMARY

Embodiments of this application provide an image processing method and apparatus, an electronic device, a computer-readable storage medium, and a computer program product, to enable a generated target text to describe a target image as accurately as possible, and ensure accuracy of the target text.

Other features and advantages of this application will become clear through the following detailed descriptions or partially learned through the practice of this application.

According to an aspect of the embodiments of this application, an image processing method is provided, including: obtaining a target image to be processed; inputting the target image to a pre-trained image-text model, a model loss of the image-text model including an image loss, and the image loss being constructed according to a first sample image and a second sample image that is obtained by converting a first sample text configured for describing the first sample image; and obtaining a target text configured for describing the target image and generated by the image-text model.

According to an aspect of the embodiments of this application, an image processing apparatus is provided, including: an obtaining module, configured to obtain a target image to be processed; and an input module, configured to input the target image to a pre-trained image-text model, a model loss of the image-text model including an image loss, and the image loss being constructed according to a first sample image and a second sample image that is obtained by converting a first sample text configured for describing the first sample image, the obtaining module being further configured to obtain a target text configured for describing image content of the target image and generated by the image-text model.

According to an aspect of the embodiments of this application, an embodiment of this application provides an electronic device, including: one or more processors; and a storage apparatus, configured to store one or more computer programs, the one or more computer programs, when executed by the one or more processors, causing the electronic device to implement the image processing method described above.

According to an aspect of the embodiments of this application, an embodiment of this application provides a computer-readable storage medium, having a computer program stored therein, the computer program, when executed by a processor of an electronic device, causing the electronic device to perform the image processing method described above.

According to an aspect of the embodiments of this application, an embodiment of this application provides a computer program product, including a computer program, the computer program being stored in a computer-readable storage medium, and a processor of an electronic device being configured to read the computer program from the computer-readable storage medium and execute the computer program, causing the electronic device to perform the image processing method described above.

In technical solutions provided in the embodiments of this application, the target image to be processed is inputted to the image-text model. The model loss of the image-text model includes the image loss, where the image loss is constructed according to the first sample image and the second sample image that is obtained by converting the first sample text configured for describing the first sample image. The second sample image obtained through image-to-text generation and text-to-image generation can better reflect a consistency status of image content in a conversion process. Further, based on the image loss constructed based on the first sample image in an image-to-text stage and the second sample image in a text-to-image stage, the image-text model obtained through image loss training can improve a situation in which content information is lost in the conversion process, and ensure consistent image content. Further, the target text generated by the image-text model can describe the target image as much as possible, thereby ensuring accuracy of the target text.

The above general descriptions and the following detailed descriptions are merely exemplary and illustrative, and cannot limit this application.

### BRIEF DESCRIPTION OF THE DRAWINGS

FIG. 1 is an example schematic diagram of an implementation environment involved in this application.

FIG. 2 is an example flowchart of an image processing method according to an exemplary embodiment of this application.

FIG. 3 is an example flowchart of another image processing method according to an exemplary embodiment of this application.

FIG. 4 is an example flowchart of another image processing method according to an exemplary embodiment of this application.

FIG. 5 is an example flowchart of another image processing method according to an exemplary embodiment of this application.

FIG. 6 is an example flowchart of another image processing method according to an exemplary embodiment of this application.

FIG. 7 is an example flowchart of another image processing method according to an exemplary embodiment of this application.

FIG. 8 is an example flowchart of another image processing method according to an exemplary embodiment of this application.

FIG. 9 is an example flowchart of another image processing method according to an exemplary embodiment of this application.

FIG. 10 is an example flowchart of another image processing method according to an exemplary embodiment of this application.

FIG. 11 is an example flowchart of another image processing method according to an exemplary embodiment of this application.

FIG. 12 is an example flowchart of an image processing method according to an exemplary embodiment of this application.

FIG. 13 is an example flowchart of another image processing method according to an exemplary embodiment of this application.

FIG. 14 is an example schematic structural diagram of a to-be-trained model according to an exemplary embodiment of this application.

FIG. 15 is an example flowchart of processing of a reverse module according to another exemplary embodiment of this application.

FIG. 16 is an example schematic diagram of forward diffusion and reverse diffusion according to an exemplary embodiment of this application.

FIG. 17 is an example schematic flowchart of denoising according to an exemplary embodiment of this application.

FIG. 18 is an example flowchart of processing of a caption module according to another exemplary embodiment of this application.

FIG. 19 is an example structural block diagram of an image processing apparatus according to an exemplary embodiment of this application.

FIG. 20 is an example schematic structural diagram of a computer system adapted to implement an electronic device according to an embodiment of this application.

### DESCRIPTION OF EMBODIMENTS

Exemplary embodiments are described in detail herein, and examples of the exemplary embodiments are shown in the accompanying drawings. When the following descriptions are made with reference to accompanying drawings, unless otherwise indicated, the same numbers in different accompanying drawings represent the same or similar elements. The following implementations described in the following exemplary embodiments do not represent all implementations that are consistent with this application. On the contrary, the implementations are merely examples of an apparatus and a method that are consistent with some aspects of this application and that are described in detail in the appended claims.

The block diagrams shown in the accompanying drawings are merely functional entities and do not necessarily correspond to a physically independent entity. To be specific, these functional entities may be implemented in a software form, or these functional entities may be implemented in one or more hardware modules or integrated circuits, or these functional entities may be implemented in different networks, processor apparatuses, and/or microcontroller apparatuses.

The flowcharts shown in the accompanying drawings are merely examples for descriptions, and do not necessarily include all content and operations. The operations are not necessarily performed in the described orders. For example, some operations may be further divided, while some operations may be combined or partially combined. Therefore, an actual execution order may change according to an actual case.

The term “plurality of” mentioned in this application means two or more. The term “and/or” describes an association relationship between associated objects, and represents that three relationships may exist. For example, A and/or B may represent the following three cases: Only A exists, both A and B exist, and only B exists. The character “/” generally represents that associated objects in the context are in an “or” relationship.

The technical solutions in the embodiments of this application involve the field of artificial intelligence (AI) technologies. Before the technical solutions in the embodiments of this application are described, the AI technologies are first briefly described. AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

Machine learning (ML) is a multi-field interdiscipline, and relates to a plurality of disciplines such as the probability theory, statistics, the approximation theory, convex analysis, and the algorithm complexity theory. The machine learning specializes in studying how a computer simulates or implements a human learning behavior to obtain new knowledge or skills, and reorganize an existing knowledge structure, so as to keep improving its performance. The machine learning, as a core of the AI, is a fundamental way to make the computer intelligent, and is applied throughout various fields of the AI. The machine learning and deep learning generally include technologies such as an artificial neural network, a confidence network, reinforcement learning, transfer learning, inductive learning, and learning from demonstration.

The technical solutions in the embodiments of this application specifically relate to a machine learning technology in AI. Specifically, an image-text model is obtained through pre-training based on the machine learning technology, to convert an image into a text. The following describes the technical solutions in the embodiments of this application in detail.

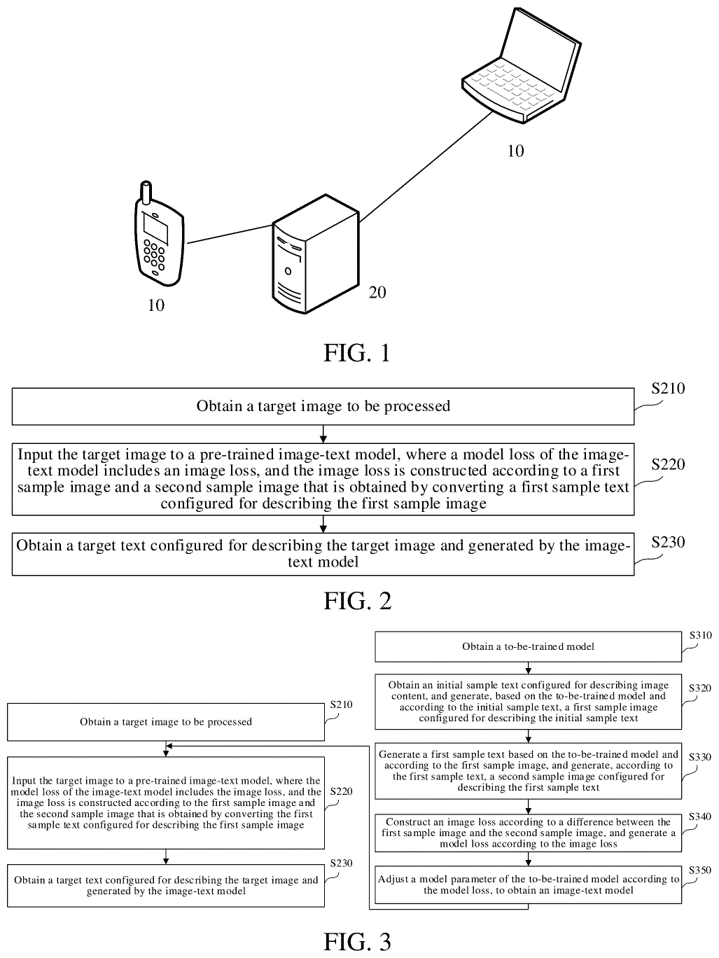

FIG. 1 is a schematic diagram of an implementation environment involved in this application. The implementation environment includes a terminal 10 and a server 20.

The terminal 10 is configured to send a target image to be processed to the server 20.

The server 20 is configured to input the target image to a pre-trained image-text model, to obtain a target text configured for describing the target image and generated by the image-text model. A model loss of the image-text model includes an image loss, where the image loss is constructed according to a first sample image and a second sample image that is obtained by converting a first sample text configured for describing the first sample image.

In some embodiments, the server 20 may send the target text to the terminal 10, and the terminal 10 may execute a downstream task based on the target text, for example, train a downstream model, or generate a new image based on the target text.

In some embodiments, the server 20 may alternatively obtain the target image to be processed, and then input the target image to the image-text model, to obtain a target text generated after the image-text model processes the target image, to perform subsequent processing based on the target text.

In some embodiments, the terminal 10 may alternatively independently implement image processing. To be specific, the terminal 10 obtains the target image to be processed, and then inputs the target image to the image-text model, to obtain a target text generated after the image-text model processes the target image.

The foregoing terminal 10 may be any electronic device capable of obtaining a target video and an image to be processed, such as a smartphone, a tablet, a notebook computer, a computer, an intelligent voice interaction device, a smart home appliance, an in-vehicle terminal, and an aircraft. The server 20 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. This is not limited herein.

The terminal 10 and the server 20 establish a communication connection through a network in advance, so that the terminal 10 and the server 20 can communicate with each other through the network. The network may be a wired network, or may be a wireless network. This is not limited herein.

In the embodiments of this application, image-text conversion may be performed on various images, and may be applied to various scenarios, including but not limited to images in various scenarios such as a cloud technology, artificial intelligence (AI), intelligent traffic, and assisted driving, or image conversion may be performed on images in an image processing application program.

Specifically, if the technical solutions in the embodiments of this application are applied to an intelligent traffic scenario, the terminal may be an in-vehicle terminal. The in-vehicle terminal uses an image captured by a dashboard camera as a target image to be processed, inputs the target image to be processed to the image-text model, further obtains a target text generated by the image-text model and describing the target image, and then plays the target text through a player, so that a driver can learn various information in the road even if not observing a related event in the road.

For another example, the technical solutions in the embodiments of this application are applied to an image processing application program. The server may be an image processing server. For example, the image processing server obtains a target image to be processed uploaded by an object, inputs the target image to the image-text model, and further obtains a target text generated by the image-text model and describing the target image. The server executes a downstream task based on the target text, for example, trains a language model.

In a specific implementation of this application, the target image involves information related to the object. When the embodiments of this application are applied to specific products or technologies, permissions or consents of the object are required. Collection, use, and processing of relevant data need to comply with relevant laws, regulations, and standards of relevant countries and regions.

Various implementation details of the technical solutions of the embodiments of this application are described below in detail.

FIG. 2 is a flowchart of an image processing method according to an embodiment of this application. The method may be applied to the implementation environment shown in FIG. 1. The method may be performed by a computer device, for example, the foregoing terminal or server. Specifically, the method may be performed by a terminal or a server, or may be performed jointly by the terminal and the server. In this embodiment of this application, an example in which the method is performed by the server is used for description, and the image processing method may include S210 to S230, which are described in detail as follows.

S210: Obtain a target image to be processed.

In this embodiment of this application, the target image to be processed may be any image having image content, for example, a landscape painting or a portrait.

In an example, the target image to be processed may be a frame of image in a video, that is, a process of obtaining the target image to be processed is: reading each frame of image in the video at a specified frame rate or time interval, and randomly selecting a frame from the read frames of images or selecting a key frame as the target image.

In an example, the target image to be processed may be obtained through transmission from another device, for example, receiving transmission of an image acquisition device. Alternatively, the target image may be directly downloaded from a network, or may be uploaded by an object.

In a specific implementation of this application, the obtained target image involves information related to the object. When this embodiment of this application is applied to specific products or technologies, any of which requires to obtain an independent permission or consent of the object. In addition, collection, use, and processing of relevant object information need to comply with relevant laws, regulations, and standards of relevant countries and regions.

For example, if the target image is a portrait image, before the portrait image is obtained and the portrait image is processed, a corresponding information processing rule is notified to an object included in the portrait image, for example, processing rules corresponding to facial recognition, facial feature extraction, and the like of the object are involved, independent agreement of the target object is solicited, related information is processed strictly complying with legal and regulation requirements and personal information processing rules, and technical measures are taken to ensure security of related data.

S220: Input the target image to a pre-trained image-text model. A model loss of the image-text model includes an image loss, where the image loss is constructed according to a first sample image and a second sample image that is obtained by converting a first sample text configured for describing the first sample image.

In this embodiment of this application, the image-text model is a model that has been trained, and is configured to perform image-text conversion on an image, that is, convert the image into a text. For example, an image of a traffic flow in a road captured by a camera is converted into a text “there are continuously running vehicles in the road”. Therefore, after the target image is inputted to the image-text model, a target text configured for describing image content of the target image may be obtained.

The model loss of the image-text model includes the image loss. Further, in a training stage, the image-text model may be obtained through training according to the image loss. The image loss is constructed according to the first sample image and the second sample image that is obtained by converting the first sample text configured for describing the first sample image. For example, there is a first sample image A1 and a first sample text B1 configured for describing the first sample image A1. The first sample text B1 is converted to obtain a second sample image A2. The image loss is constructed according to the first sample image A1 and the second sample image A2. In an example, the first sample text B1 may be obtained by converting the first sample image A1.

As described above, the first sample text is configured for describing the first sample image. Content expressed by the first sample text and content expressed by the first sample image are the same. However, the second sample image is obtained by converting the first sample text, where image-text conversion is performed. In this way, image content of the first sample image may be the same as or different from image content of the second sample image. Further, the image loss may be constructed by using the image content of the first sample image and the image content of the second sample image, to represent a consistency status of content information in a conversion process. Further, the image-text model obtained through image loss training can improve a situation in which the content information is loss in the conversion process. Therefore, after the image-text conversion is performed, a text generated by the image-text model can describe the image as accurately as possible.

S230: Obtain a target text configured for describing the target image and generated by the image-text model.

In this embodiment of this application, after the target image is inputted to the image-text model, the image-text model may be directly obtained to perform image-text conversion, to obtain the target text. Because the image-text model is constructed according to the image loss, image content included in the target image is not lost, and has the same meaning as that expressed by the target text, so that the text is used to describe the image content as accurately as possible.

In this embodiment of this application, the target image to be processed is inputted to the image-text model. The model loss of the image-text model includes the image loss, where the image loss is constructed according to the first sample image and the second sample image that is obtained by converting the first sample text configured for describing the first sample image. The second sample image obtained through image-to-text generation and text-to-image generation can better reflect a consistency status of image content in a conversion process. Further, based on the image loss constructed based on the first sample image and the second sample image, the image-text model obtained through image loss training can improve a situation in which content information is lost in the conversion process, and ensure consistent image content. Further, the target text generated by the image-text model can describe the target image as much as possible, thereby ensuring accuracy of the target text.

In an embodiment of this application, another image processing method is provided. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 3, a training process of the image-text model is added to the image processing method before S220 in FIG. 2 based on S210 to S230 shown in FIG. 2, including operations S310 to S350. S310 to S350 are described in detail as follows.

S310: Obtain a to-be-trained model.

In this embodiment of this application, the to-be-trained model may be a complete neural network model of a type. The to-be-trained model may alternatively be a neural network model formed by combining a plurality of neural networks of different types. This is not limited herein.

S320: Obtain an initial sample text configured for describing image content, and generate, based on the to-be-trained model and according to the initial sample text, a first sample image configured for describing the initial sample text.

In this embodiment of this application, the initial sample text is obtained. The initial sample text is configured for describing image content. The image content may be any content that complies with laws and regulations, and is not limited herein. An obtaining manner may be extracting from a network, or may be uploaded by an object.

After the initial sample text is obtained, the first sample image is generated according to the initial sample text. The first sample image is configured for describing the initial sample text, that is, expressing text content in a form of an image.

In an example, the initial sample text may be inputted to the to-be-trained model. The to-be-trained model includes a network structure that can implement text-to-image generation. Further, an image matching a text description may be generated from the description by using the to-be-trained model, to generate a first sample image. For example, the text is converted into an image space, and a visual feature and language information are associated with each other, to implement mapping between the text and the image.

S330: Generate a first sample text based on the to-be-trained model and according to the first sample image, and generate, according to the first sample text, a second sample image configured for describing the first sample text.

In an example, after the first sample image is obtained, the first sample image may be inputted to the to-be-trained model. The to-be-trained model includes a network structure that can implement an image-to-text process. Further, the first sample text may be generated by using the to-be-trained model, and the first sample image is described by using the first sample text.

In this embodiment of this application, the second sample image is generated according to the first sample text, and the first sample text is described by using the second sample image. To better construct an image loss subsequently, a manner of generating the first sample image according to the initial sample text is different from a manner of generating the second sample image according to the first sample text. For example, the initial sample text is generated according to the first sample image by using a first network structure that implements text-to-image generation, the first sample text is generated according to the second sample image by using a second network structure that implements text-to-image generation, and the first network structure is different from the second network structure, so that a difference between processing results of content information is reflected by using different network structures.

S340: Construct the image loss according to a difference between the first sample image and the second sample image, and generate a model loss according to the image loss.

In this embodiment of this application, from the initial sample text to the first sample image, from the first sample image to the first sample text, and then from the first sample text to the second sample image, text-to-image generation, image-to-text generation, and text-to-image generation are performed. During this period, image content of the described sample text may be changed. For the to-be-trained model to better learn a mapping relationship between an image and a text, the image loss is constructed by using the difference between the first sample image and the second sample image. The difference between the first sample image and the second sample image refers to a similarity between the first sample image and the second sample image.

After the image loss is generated, the model loss is generated according to the image loss. For example, after the image loss is processed, for example, after a weight is set, the model loss is generated.

S350: Adjust a model parameter of the to-be-trained model according to the model loss, to obtain an image-text model.

The model parameter of the to-be-trained model is adjusted according to the model loss until a network of the to-be-trained model converges, to obtain the trained image-text model.

For other detailed descriptions of S210 to S230 shown in FIG. 3, reference is made to S210 to S230 shown in FIG. 2. Details are not described herein again.

In this embodiment of this application, the first sample image is generated by using the initial sample text describing the image content, that is, the first sample image and the second sample image are obtained through text-to-image, image-to-text, and text-to-image conversion processes. Further, the image loss is constructed based on the difference between the first sample image and the second sample image, so that the image loss can better measure consistency of the image content. Further, during subsequent model training, the model can avoid the loss of the image content, and the generated text can describe the image as accurately as possible.

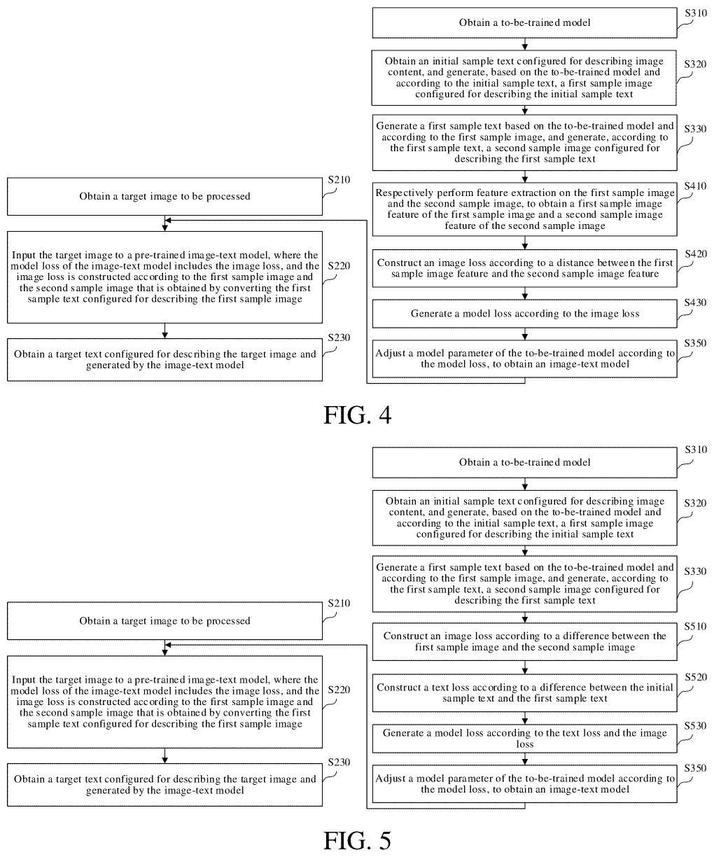

An embodiment of this application provides another image processing method. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 4, S340 shown in FIG. 3 is extended to S410 to S430 based on illustration of FIG. 3. S410 to S430 are described in detail below.

S410: Respectively perform feature extraction on the first sample image and the second sample image, to obtain a first sample image feature of the first sample image and a second sample image feature of the second sample image.

In this embodiment of this application, the feature extraction is respectively performed on the first sample image and the second sample image. Feature extraction manners may be the same or may be different. For example, the first sample image is extracted by calculating a gradient direction and strength of each pixel in the image, to obtain the first sample image feature. A multi-scale analysis is performed on the second sample image, to extract a feature having rotation invariance and scale invariance, to obtain the second sample image feature of the second sample image.

If feature formats of the first sample image feature and the second sample image feature are different, normalization further needs to be performed on the first sample image feature and the second sample image feature, to ensure that the feature formats are consistent, to facilitate subsequent construction of the image loss.

S420: Construct the image loss according to a distance between the first sample image feature and the second sample image feature.

In this embodiment of this application, a difference between image features is reflected by the distance between the first sample image feature and the second sample image feature, and a shorter distance indicates a smaller difference. A similarity between the first sample image feature and the second sample image feature may be calculated, and the similarity is used as the distance between the first sample image feature and the second sample image feature.

In an example, the similarity between the first sample image feature and the second sample image feature may be calculated by using a cosine similarity, or may be calculated by using a Euclidean distance.

S430: Generate the model loss according to the image loss.

For the detailed descriptions of S210 to S230, S310 to S330, and S350 shown in FIG. 4, reference is made to S210 to S230, S310 to S330, and S350 shown in FIG. 3. Details are not described herein again.

In this embodiment of this application, the similarity between the first sample image and the second sample image may be reflected by using the distance between the first sample image feature of the first sample image and the second sample image feature of the second sample image, thereby ensuring accuracy of the constructed image loss.

An embodiment of this application further provides another image processing method. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 5, S340 shown in FIG. 3 is extended to S510 to S530 based on illustration of FIG. 3. S510 to S530 are described in detail below.

S510: Construct the image loss according to the difference between the first sample image and the second sample image.

S520: Construct a text loss according to a difference between the initial sample text and the first sample text.

In this embodiment of this application, the text loss is configured for representing a loss status of text content in an image-text conversion process.

As described above, before the first sample text is generated, text semantics describing the image content may be changed after the text-to-image generation and the image-to-text generation. For the to-be-trained model to better learn a mapping relationship between an image and a text, the text loss is constructed by using the difference between the initial sample text and the first sample text. The difference between the initial sample text and the first sample text refers to a similarity between the initial sample text and the first sample text.

S530: Generate the model loss according to the text loss and the image loss.

In an example, a sum of the text loss and the image loss may be used as the model loss.

In an example, a weight may be configured for the text loss and the image loss, and a weighted sum of the text loss and the image loss is used as the model loss.

For other detailed descriptions of S210 to S230, S310 to S330, and S350 shown in FIG. 5, reference is made to S210 to S230, S310 to S330, and S350 shown in FIG. 3. Details are not described herein again.

In this embodiment of this application, consistency of the image content in the conversion process is considered, and consistency of the text description in the conversion process is considered. The text loss is constructed by using the initial sample text and the first sample text, so that the model undergoes multiple constraints of the text and the image, to ensure that the subsequent model can avoid information loss of the image content and the text description.

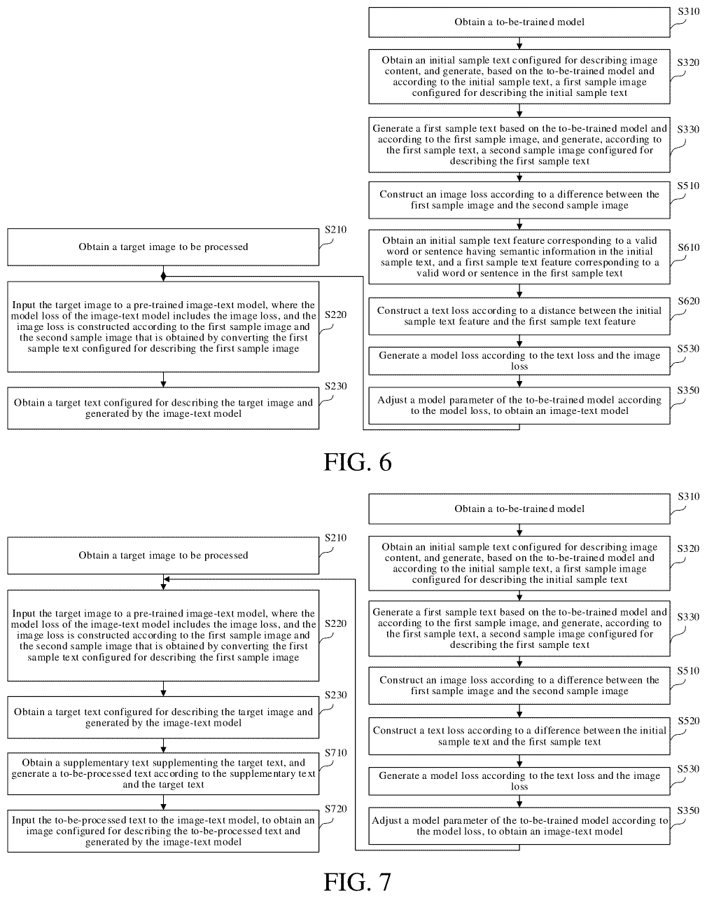

In an embodiment of this application, another image processing method is further provided. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 6, in the image processing method, S520 is extended to S610 and S620 based on illustration of FIG. 5. S610 and S620 are described in detail below.

S610: Obtain an initial sample text feature corresponding to a valid word or sentence having semantic information in the initial sample text, and a first sample text feature corresponding to a valid word or sentence in the first sample text.

In this embodiment of this application, words in the initial sample text and the first sample text may be different. First, a valid word or sentence in the initial sample text needs to be obtained. The valid word or sentence includes a word or sentence having semantic information, for example, “dance”, while words such as “of” and “is/are” are invalid words. Sentences whose elements have unclear relationships, or sentences whose meanings cannot be understood without context are sentences having no semantics. For example, a single sentence “That event is very serious” is a sentence having no semantics.

Similarly, a valid word or sentence is extracted from the first sample text, then feature extraction is performed on the valid word or sentence in the initial sample text to obtain an initial sample text feature, and feature extraction is performed on the valid word or sentence in the first sample text to obtain a first sample text feature. Manners of performing feature extraction on the initial sample text and the first sample text may be the same or may be different. For example, the valid word or sentence is converted into a vector representation, the valid word or sentence is associated with a context valid word or sentence around the valid word or sentence, and a distributed representation of the valid word or sentence is learned, to obtain the initial sample text feature. For another example, a structure of the valid word or sentence is analyzed, and grammar information such as a noun, a verb, and an adjective in the sentence is extracted as the first sample text feature.

If feature forms of the initial sample text feature and the first sample text feature are different, the initial sample text feature and the first sample text feature further need to be processed, to unify a feature form, to facilitate subsequent construction of the text loss.

In some examples, to improve efficiency of the feature extraction, after the valid word or sentence is extracted from the sample text, words having a distinguishing capability may further be selected from the valid word or sentence for feature extraction. For example, if a word or phrase frequently occurs in an article and rarely occurs in another article, it is considered that the word or phrase has a good category distinguishing capability.

S620: Construct the text loss according to a distance between the initial sample text feature and the first sample text feature.

In this embodiment of this application, a difference between text features is reflected by the distance between the initial sample text feature and the first sample text feature, and a smaller distance indicates a smaller difference. A similarity between the initial sample text feature and the first sample text feature may be calculated, and the similarity is used as the distance between the initial sample text feature and the first sample text feature.

In an example, the similarity between the text features may be calculated by using a cosine similarity, or may be calculated by using a Euclidean distance.

For other detailed descriptions of S210 to S230, S310 to S330, S510, S530 and S350 shown in FIG. 6, reference is made to S210 to S230, S310 to S330, S510, S530 and S350 shown in FIG. 5. Details are not described herein again.

In this embodiment of this application, the distance between the initial sample text feature corresponding to the valid word or sentence having the semantic information in the initial sample text and the first sample text feature corresponding to the valid word or sentence in the first sample text may reflect the similarity between the initial sample text and the first sample text, thereby ensuring accuracy of the constructed text loss.

In an embodiment of this application, another image processing method is further provided. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 7, in the image processing method, a process of implementing text-to-image generation by using the image-text model is added after S230 based on illustration of FIG. 5, where the process includes S710 and S720. S710 to S720 are described in detail below.

S710: Obtain a supplementary text supplementing the target text, and generate a to-be-processed text according to the supplementary text and the target text.

The image-text model in this embodiment of this application can implement the image-to-text generation and the text-to-image generation. After the target text describing the image content of the target image to be processed is obtained, the target text may be supplemented. This means adding new content such as information, opinions, and data based on the target text, to make the text more complete and accurate. For example, the supplementary text is obtained based on detailed content of a context supplementary event or object of the target text.

After the supplementary text is obtained, the target text and the supplementary text may be modified and improved, to obtain the to-be-processed text, so that the to-be-processed text is smoother, easier to read, and more logical.

S720: Input the to-be-processed text to the image-text model, to obtain an image that is configured for describing the to-be-processed text and that is generated by the image-text model.

The to-be-processed text is inputted to the image-text model. The model loss of the image-text model includes the text loss and the image loss, so that the image-text model can fully learn a mapping relationship between an image and a text, and then obtain an image that is configured for describing the to-be-processed text and that is generated by the image-text model.

For other detailed descriptions of operations S210 to S230, S310 to S330, S510 to S530, and S350 shown in FIG. 7, reference is made to operations S210 to S230, S310 to S330, S510 to S530, and S350 shown in FIG. 5. Details are not described herein again.

In this embodiment of this application, the image-text model not only may be applied to an application scenario of text-to-image generation, but also may be applied to an application scenario of image-to-text generation. Supplementation is performed on the target text to generate the to-be-processed text, to generate a more detailed image based on the to-be-processed text, which can satisfy various requirements for re-painting the image.

In an embodiment of this application, another image processing method is further provided. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 8, in the image processing method, S320 is extended to S810 to S830 based on illustration of FIG. 3. S810 to S830 are described in detail below.

S810: Obtain the initial sample text configured for describing the image content, and perform feature extraction on the initial sample text based on the to-be-trained model, to obtain an initial sample text vector.

In this embodiment of this application, the feature extraction is performed on the initial sample text. The inputted initial sample text may be encoded into a representation vector by using a text encoder module, to obtain the initial sample text vector.

S820: Obtain a random noise-added sample image.

In this embodiment of this application, the random noise-added sample image refers to a sample image using random Gaussian noise. In an example, the random noise-added sample image is in a latent space.

S830: Perform denoising on the random noise-added sample image based on the to-be-trained model and according to the initial sample text vector, to obtain the first sample image.

In this embodiment of this application, the denoising is performed on the random noise-added sample image based on the initial sample text vector, and semantics of the initial sample text are injected step by step, to obtain the first sample image describing the initial sample text.

In an example, a denoising process includes: inputting the initial sample text vector and the random noise-added sample image to a denoising module in the to-be-trained model, and the denoising module iteratively performing denoising on the random noise-added sample image by using the initial sample text vector as a condition, where the denoising module may predict noise based on the random noise-added sample image and the initial sample text vector, then subtract the predicted noise from the random noise-added sample image, to obtain a predicted denoised image representation; and predicting noise again based on the predicted denoised image representation and the initial sample text vector, subtracting the predicted noise again by using the predicted denoised image representation, and performing iteration for a plurality of times, where in a denoising process, noise may be predicted by using an injected initial sample text vector, and the predicted noise is subtracted step by step, to obtain a first sample image conforming to a text corresponding to the initial sample text vector. The first sample image can accurately describe the initial sample text.

For other detailed descriptions of S210 to S230, S310, and S330 to S350 shown in FIG. 8, reference is made to S210 to S230, S310, and S330 to S350 shown in FIG. 3. Details are not described herein again.

In this embodiment of this application, the feature extraction is performed on the initial sample text, to obtain the initial sample text vector. The denoising is performed on the random noise-added sample image according to the initial sample text vector. That is, semantic information is injected in the denoising process, to ensure that the generated first sample image can accurately describe the initial sample text.

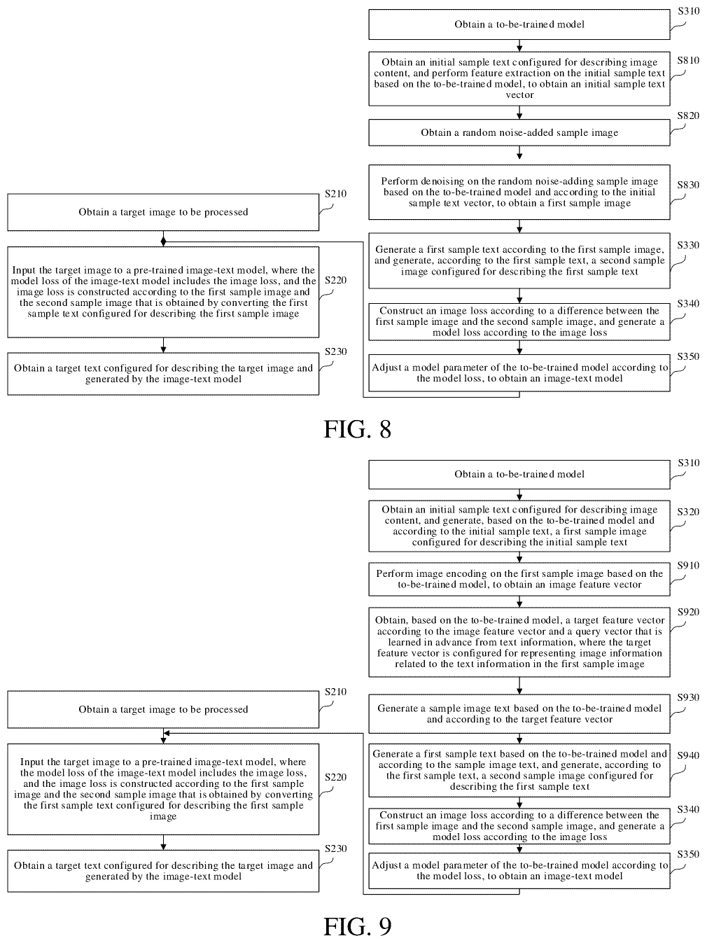

In an embodiment of this application, another image processing method is further provided. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 9, in the image processing method, S330 is extended to S910 to S940 based on illustration of FIG. 3. S910 to S940 are described in detail below.

S910: Perform image encoding on the first sample image based on the to-be-trained model, to obtain an image feature vector.

In this embodiment of this application, the first sample image may be inputted to an image encoder, to perform image encoding on the first sample image. The image encoder is configured to extract a feature vector from an image, perform quantization on the extracted feature vector before performing compression encoding. After image encoding is performed, all feature vectors are extracted from the image encoder, to obtain the image feature vector. The image feature vector includes but is not limited to a pixel value, an edge, and a color feature in the image.

S920: Obtain, based on the to-be-trained model, a target feature vector according to the image feature vector and a query vector that is learned in advance from text information, where the target feature vector is configured for representing image information related to the text information in the first sample image.

In this embodiment of this application, the query vector learned by using the text information in advance needs to be first obtained. The query vector is obtained by learning a visual-language feature vector based on preset text information and an image set. All image information related to a text in the image feature vector may be learned according to the query vector, to extract a text-related feature, to obtain the target feature vector. In this way, the target feature vector may represent the image information related to the text information in the first sample image.

S930: Generate a sample image text based on the to-be-trained model and according to the target feature vector.

In this embodiment of this application, the target feature vector may be directly inputted to a language model, and the target feature vector is processed by using the language model, to generate the sample image text. In an example, the language model may be a large language model (LLM), and has a neural network model for generating a text, a text encoder-decoder, and the like.

In an example, because the target feature vector is configured for representing the image information related to the text information in the first sample image, a target sample language label may be generated according to the target feature vector and a preset language label. For example, a feature vector corresponding to key text information is first extracted from the target feature vector, including features such as a shape, a color, and a size of an object, and the extracted feature vector corresponding to the key text information is compared with the preset language label, to obtain a most matching label, that is, the target sample language label. The target sample language label may be at least one of a word, a short sentence, or an entire sentence. Further, grammar and semantics of a text may be predicted according to the target sample language label, and then a text description is generated based on the predicted grammar and semantics of the text, to convert the target feature vector into a sample image text.

S940: Generate a first sample text based on the to-be-trained model and according to the sample image text, and generate, according to the first sample text, a second sample image configured for describing the first sample text.

In an example, the sample image text may be directly used as the first sample text.

In an example, the sample image text may further be processed, for example, text augmentation may be performed, and the first sample text is generated based on the processed text.

For a process of generating the second sample image based on the first sample text, refer to subsequent embodiments.

For other detailed descriptions of S210 to S230, S310 and S320, and S340 and S350 shown in FIG. 9, reference is made to S210 to S230, S310 and S320, and S340 and S350 shown in FIG. 3. Details are not described herein again.

In this embodiment of this application, the image feature vector of the first sample image is obtained through image encoding, the target feature vector configured for representing the image information related to the text information in the first sample image is obtained based on the image feature vector and the learned query vector, and the sample image text is generated, so that the obtained sample image text can accurately describe the sample image.

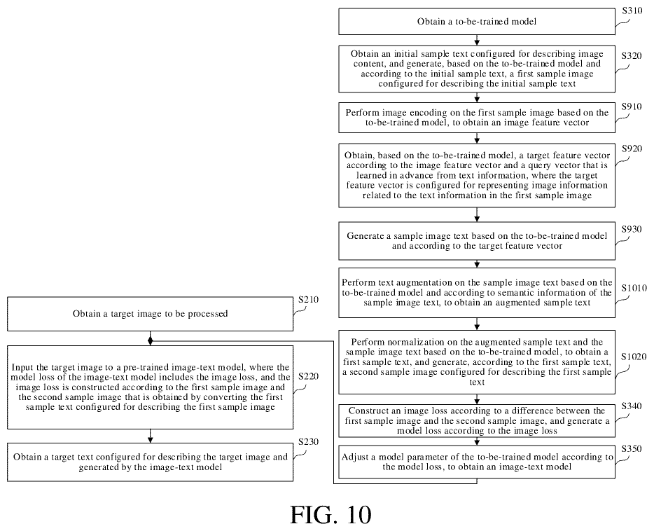

In an embodiment of this application, another image processing method is further provided. The image processing method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 10, in the image processing method, S940 is extended to S1010 and S1020 based on illustration of FIG. 9. S1010 and S1020 are described in detail below.

S1010: Perform text augmentation on the sample image text based on the to-be-trained model and according to semantic information of the sample image text, to obtain an augmented sample text.

In this embodiment of this application, to sufficiently learn various text forms for describing image content by the to-be-trained model, after the sample image text is generated based on the first sample image, the text augmentation is performed on the sample image text. The text augmentation is performed according to the semantic information of the sample image text, to ensure that meanings for describing the image content are the same.

In an example, synonym replacement may be performed on some words in the sample image text according to the semantic information of the sample image text, that is, some words in an original text are replaced with words having meanings close to those in the original text, to enlarge vocabulary, to obtain the augmented sample text. The sentences in the sample image text may further be recombined to generate a new sentence, but semantic information of the new sentence is the same as semantic information of the sentence in the sample image text, to obtain the augmented sample text.

In an example, a language form in the sample image text is extended according to the semantic information of the sample image text, to obtain an extended sample text. For example, a sample image text in a Chinese form is augmented into a sample image text in another language form, such as a sample image text in English and a sample image text in Japanese.

In an example, the text augmentation is performed on the sample image text. For example, some words or short sentences are randomly inserted into the sample image text, or some words or short sentences are randomly deleted to increase text complexity, to obtain the augmented sample text. Semantic information of the augmented sample text is the same as that of the sample image text.

S1020: Perform normalization on the augmented sample text and the sample image text based on the to-be-trained model, to obtain a first sample text, and generate, according to the first sample text, the second sample image configured for describing the first sample text.

In this embodiment of this application, to ensure that formats of the augmented sample text and the sample image text are consistent, the normalization is performed on the augmented sample text and the sample image text, to summarize statistics distribution of the unified samples, to obtain the first sample text. The first sample text includes the sample image text and the augmented sample text.

For a specific process of generating the second sample image configured for describing the first sample text, refer to subsequent embodiments.

For other detailed descriptions of operations S210 to S230, S310 and S320, S910 to S930, and S340 and S350 shown in FIG. 10, reference is made to operations S210 to S230, S310 and S320, S910 to S930, and S340 and S350 shown in FIG. 9. Details are not described herein again.

In this embodiment of this application, the text augmentation is performed on the sample image text by using the semantic information of the sample image text, so that the generated first sample text has rich meanings based on the augmented sample text and the sample image text, and can be applied to various scenarios, to ensure better robustness during subsequent model training.

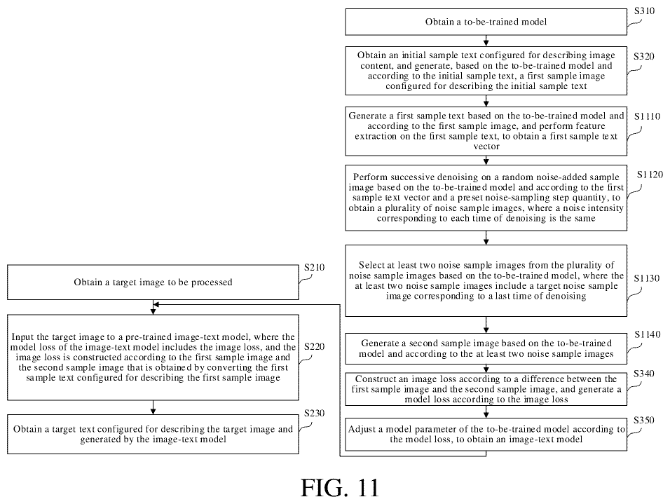

An embodiment of this application provides another image processing method. The method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 11, in the image processing method, S330 is extended to S1110 to S1140 based on illustration of FIG. 3. S1110 to S1140 are described in detail below.

S1110: Generate a first sample text based on the to-be-trained model and according to the first sample image, and perform feature extraction on the first sample text, to obtain a first sample text vector.

In this embodiment of this application, the feature extraction is performed on the first sample text. An inputted first sample text may be encoded into a representation vector by using a text encoder, to obtain the first sample text vector.

S1120: Perform successive denoising on a random noise-added sample image based on the to-be-trained model and according to the first sample text vector and a preset noise-sampling step quantity, to obtain a plurality of noise sample images, where a noise intensity corresponding to each time of denoising is the same.

In this embodiment of this application, the random noise-added sample image and the preset noise-sampling step quantity are first obtained. The preset noise-sampling step quantity includes a step quantity of performing denoising. For example, if the preset noise-sampling step quantity is 50, denoising needs to be performed on the random noise-added sample image for 50 times, where noise intensities corresponding to the noise-sampling step quantities are consistent.

In an example, the successive denoising is performed on the random noise-added sample image according to the preset noise-sampling step quantity, and during the successive denoising, semantics are injected according to the first sample text vector. The successive denoising refers to: predicting, based on the random noise-added sample image and the initial sample text vector, noise that needs to be subtracted, subtracting the predicted noise from the random noise-added sample image to obtain a first noise sample image, and then performing repetition for a plurality of times according to the preset noise-sampling step quantity, that is, predicting, based on the first noise sample image and the initial sample text vector, the noise that needs to be subtracted, and subtracting the predicted noise from the first noise sample image to obtain a second noise sample image, and so on, until the preset noise-sampling step quantity is reached, to obtain a plurality of noise sample images. A quantity of the noise sample images is the same as a number of times of denoising. The first time of denoising and the second time of denoising may correspond to different noise values, but have the same noise intensity. The noise value refers to a quantity or degree of noise existing in an image. The noise intensity refers to a degree of impact of the noise in the image, that is, a degree of impact of the noise on image quality. The noise intensity may be measured by using an index such as a signal-to-noise ratio (SNR) or a peak signal-to-noise ratio (PSNR).

S1130: Select at least two noise sample images from the plurality of noise sample images based on the to-be-trained model, where the at least two noise sample images include a target noise sample image corresponding to the last time of denoising.

In this embodiment of this application, the at least two noise sample images include the target noise sample image corresponding to the last time of denoising. The target noise sample image corresponding to the last time of denoising is a sample image having no noise value or a smallest noise value in the image after the denoising is completed. The target noise sample image may describe the first sample text to some extent.

For another noise sample image other than the target noise sample image in the at least two noise sample images, the another noise sample image is a sample image having a noise value. The another noise sample image may be randomly selected from the plurality of noise sample images, or may be selected periodically according to the number of times of denoising. This is not limited herein.

In an example, a quantity of the other noise sample images may be flexibly selected according to an actual situation, for example, determined according to the number of times of denoising. A larger number of times of denoising indicates a larger quantity of the selected other noise sample images.

S1140: Generate a second sample image based on the to-be-trained model and according to the at least two noise sample images.

In this embodiment of this application, to ensure that the generated second sample image corresponding to perturbation of the first sample text has sufficient robustness, the second sample image is generated with reference to the another noise sample image having a noise value and the target noise sample image having no noise value. In an example, intersection processing may be performed on the another noise sample image and the target noise sample image, to generate the second sample image.

For other detailed descriptions of S210 to S230, S310 and S320, and S340 and S350 shown in FIG. 11, reference is made to S210 to S230, S310 and S320, and S340 and S350 shown in FIG. 10. Details are not described herein again.

In this embodiment of this application, the successive denoising is performed on the random noise-added sample image according to the first sample text vector corresponding to the first sample text and the preset noise-sampling step quantity, to obtain the plurality of noise sample images. At least two noise sample images including the target noise sample image corresponding to the last time of denoising are selected therefrom, to generate the second sample image, thereby ensuring perturbation on the first sample text, and enabling the second sample image to have sufficient robustness.

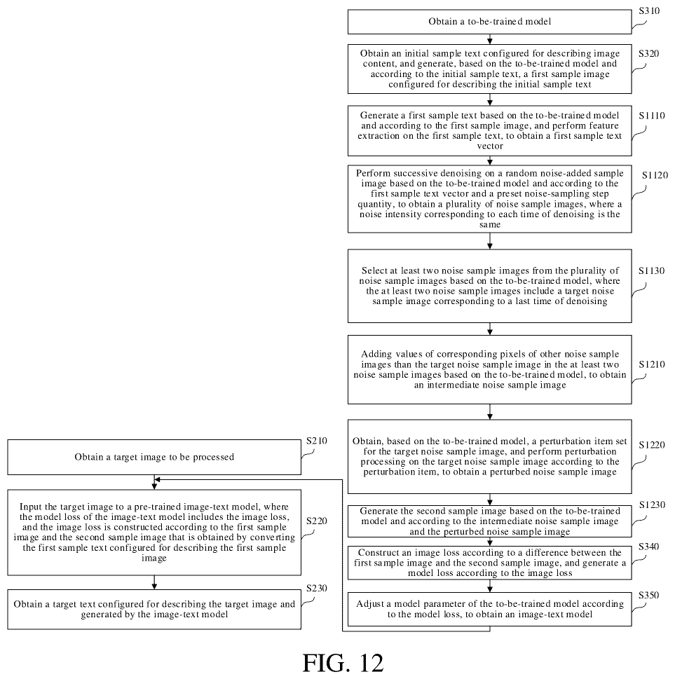

An embodiment of this application provides another image processing method. The method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 12, in the image processing method, S1140 shown in FIG. 11 is extended to S1210 to S1230 based on illustration of FIG. 11. S1210 to S1230 are described in detail below.

S1210: Adding values of corresponding pixels of other noise sample images than the target noise sample image in the at least two noise sample images based on the to-be-trained model, to obtain an intermediate noise sample image.

As described above, the other noise sample images have noise values of some extent, and the other noise sample images are first added pixel by pixel, that is, values of pixels at same positions are added, to obtain the intermediate noise sample image.

S1220: Obtain, based on the to-be-trained model, a perturbation item set for the target noise sample image, and perform perturbation processing on the target noise sample image according to the perturbation item, to obtain a perturbed noise sample image.

In this embodiment of this application, the target noise sample image has no noise value. To ensure that the second sample image has sufficient perturbation, the perturbation item preset for the target noise sample image is obtained, and the perturbation processing is performed on the target noise sample image by using the perturbation item. For example, the perturbation item is multiplied by the target noise sample image, to obtain the perturbed noise sample image.

S1230: Generate the second sample image based on the to-be-trained model and according to the intermediate noise sample image and the perturbed noise sample image.

In this embodiment of this application, intersection is performed on the intermediate noise sample image and the perturbed noise sample image, to generate the second sample image. That is, the values of the corresponding pixels of the intermediate noise sample image and the perturbed noise sample image are added, to obtain the second sample image.

For the detailed descriptions of operations S210 to S230, S310 and S320, S1110 to S1130, and S340 and S350 shown in FIG. 12, reference is made to operations S210 to S230, S310 and S320, S1110 to S1130, and S340 and S350 shown in FIG. 11. Details are not described herein again.

In this embodiment of this application, the another noise sample image and the target noise sample image are added pixel by pixel, to add sufficient perturbation to the target noise sample image.

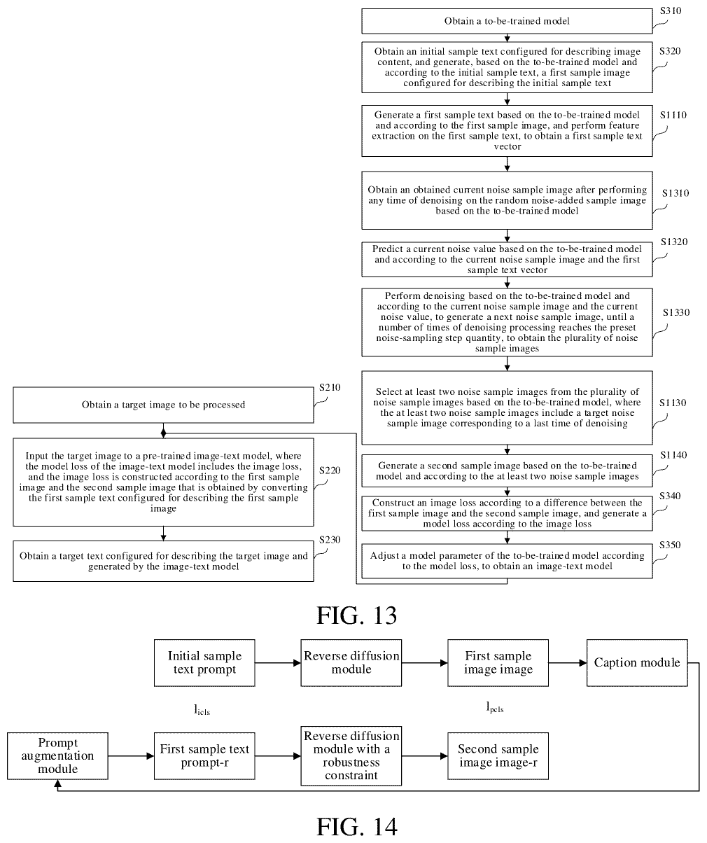

An embodiment of this application further provides another image processing method. The method may be applied to the implementation environment shown in FIG. 1. The method may be performed by a terminal or a server, or may be performed jointly by the terminal and the server. In this embodiment of this application, an example in which the method is performed by the server is used for description. As shown in FIG. 13, in the image processing method, S1120 is extended to S1310 to S1330 based on illustration of FIG. 11. S1310 to S1330 are described in detail below.

S1310: Obtain an obtained current noise sample image after performing any time of denoising on the random noise-added sample image based on the to-be-trained model.

S1320: Predict a current noise value based on the to-be-trained model and according to the current noise sample image and the first sample text vector.

In this embodiment of this application, after the denoising is performed on the random noise-added sample image for any time, the current noise sample image is obtained, and the current noise value is predicted by a pre-trained denoising module according to the current noise sample image and a current noise-sampling step quantity.

During training, in a process in which the denoising module first performs noise-adding on an image, it is considered that noise is added to a variable randomly sampled from real data distribution. After the noise is added for N (which is the preset noise-sampling step quantity) times, a sequence with a length of N is obtained. As N increases, original data loses a feature of the original data and becomes pure Gaussian noise. The denoising is a reverse process. A noise-sampling step quantity n and a noise sample image corresponding to the noise-sampling step quantity n are randomly selected. The noise sample image corresponding to the noise-sampling step quantity n and the first sample text vector are inputted to the pre-trained denoising module. The denoising module can convert the reverse process into a forward process, and then reverse the process distribution, to predict noise from the noise sample image.

S1330: Perform denoising based on the to-be-trained model and according to the current noise sample image and the current noise value, to generate a next noise sample image, until a number of times of denoising reaches the preset noise-sampling step quantity, to obtain the plurality of noise sample images.

In this embodiment of this application, the current noise value is subtracted from the current noise sample image to obtain the next noise sample image, and S1320 and S1330 are repeated, that is, a next noise value is predicted based on the next noise sample image and the first sample text vector, and then the next noise value is subtracted from the next noise sample image, to generate a next noise sample image, until the number of times of denoising reaches the preset noise-sampling step quantity, for example, reaches N. A noise sample image generated for the N^{th} time is the target noise sample image corresponding to the last time of denoising. The noise sample images generated after the denoising are assembled, to obtain the plurality of noise sample images.

For other detailed descriptions of operations S210 to S230, S310 and S320, S1110, S1130 and S1140, and S340 and S350 shown in FIG. 13, reference is made to operations S210 to S230, S310 and S320, S1110, S1130 and S1140, and S340 and S350 shown in FIG. 11. Details are not described herein again.

For case of understanding, an embodiment of this application further provides an image processing method. A description is provided by using a specific example. As shown in FIG. 14, a model structure diagram of a to-be-trained model is provided. The to-be-trained model includes a reverse diffusion module, a caption module, a prompt augmentation module, and a reverse diffusion module with a robustness constraint. A training sample of the to-be-trained model includes an initial sample text prompt. The initial sample text is converted into a first sample image image by using the reverse diffusion module, the caption module is introduced to perform text re-parsing on the first sample image, and data extension is performed on the re-parsed text by using the prompt augmentation module, to obtain a first sample text prompt-r. The first sample text is inputted to the reverse diffusion module with a robustness constraint, to generate a second sample image image-r. The initial sample text needs to be consistent with the first sample text as much as possible, and the first sample image needs to be consistent with the second sample image as much as possible. By using a multi-constraint on the sample text and the sample image, it is ensured that after an image-text model obtained through training of the to-be-trained model generates an image, a text re-parsed based on the image can describe the image as much as possible.

The foregoing reverse diffusion module, the caption module, the prompt augmentation module, and the reverse diffusion module with a robustness constraint are described in detail. The reverse diffusion module, the caption module, the prompt augmentation module, and the reverse diffusion module with a robustness constraint may be neural networks of different types.

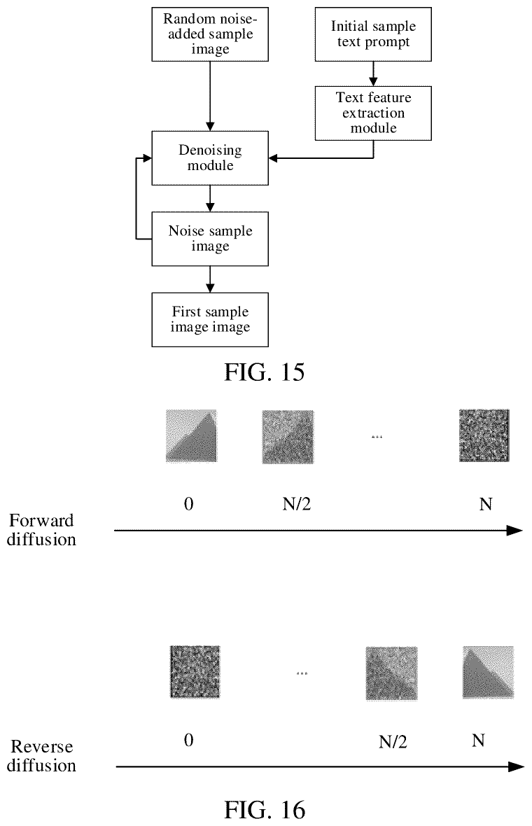

As shown in FIG. 15, the reverse diffusion module includes a text feature extraction module and a denoising module. The initial sample text passes through the text feature extraction module, to obtain text embedding. The text embedding and a random noise-added sample image (which is initialized by using a random Gaussian noise) are both inputted to the denoising module, and finally the first sample image is outputted. In an example, the text feature extraction module is a contrastive language-image pre-training (CLIP) model.

Before the denoising module is described, a forward diffusion process is described first. As shown in FIG. 16, in the forward diffusion process, which is a process of performing noise adding on an image, at the same noise intensity, noise is added with different noise-sampling step quantities N, to generate different noise images. That is, noise differences generated in step 0 (an original image), step N/2, and step N are respectively shown from left to right.

The denoising module iteratively performs denoising on the random noise-added sample image while using the text embedding as a condition, which may be considered as reverse processing of a noising-adding process, as shown in FIG. 16. That is, in a denoising process of the denoising module, a text embedding vector is injected to the denoising process by using an attention mechanism, to obtain different noise sample images.

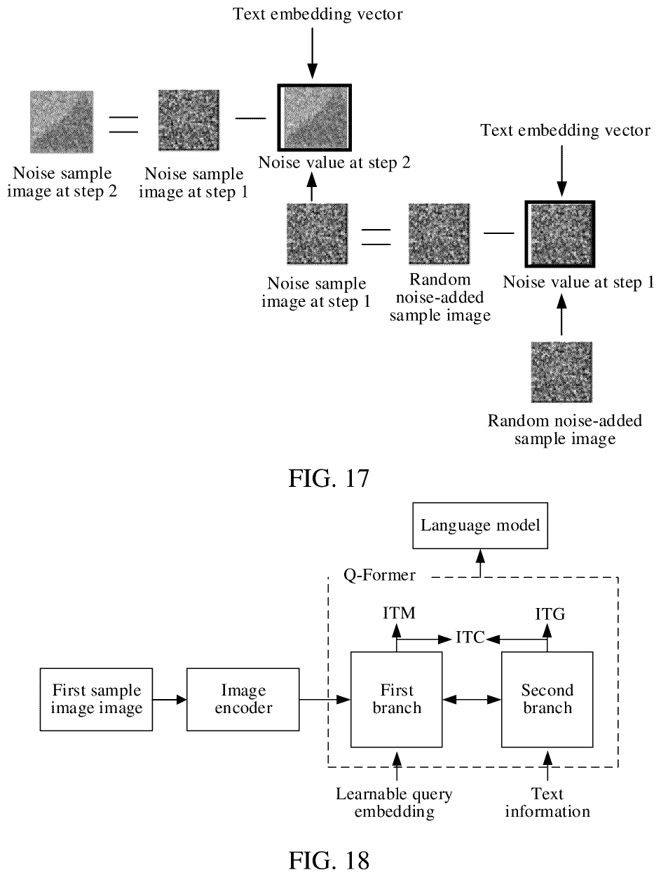

As shown in FIG. 17, a process of denoising includes: using the random noise-added sample image as a noise image at step 0, predicting a noise value at step 1 according to the random noise-added sample image and the text embedding vector, and subtracting the noise value at step 1 from the random noise-added sample image; and similarly, predicting a noise value at step 2 by using a noise sample image at step 1 and the text embedding vector, subtracting the noise value at step 2 from the noise sample image at step 1, and so on, until denoising is performed for N times, to obtain a noise sample image at step N. The noise sample image at step N is a denoised original image.

As shown in FIG. 18, the caption module includes an image encoder, a query transformation (Q-Former) module, and a language model (such as an LLM model). In a training stage of the Q-Former module, training text information is inputted to a second branch of the Q-Former module, a training image set is inputted to a first branch of the Q-Former module by using the image encoder, and a group of learnable query embeddings are used as an input of the first branch. The first branch interacts with the second branch, so that the learnable query embedding interacts with a feature outputted by the image encoder, and the learnable query embedding interacts with the training text information. In the training stage, three objectives need to be jointly optimized, which are respectively an image-text contrastive (ITC) loss: for learning to align an image representation with a text representation, to maximize mutual information of the image representation and the text representation; an image-text matching (ITM) loss: for learning fine-grained alignment between an image representation and a text representation; and based on an image-grounded text generation (ITG) loss, training the Q-Former to generate a text when an inputted image is provided as a condition. Based on the three objectives, the learnable query embedding learns a text-image feature representation, to obtain a learned query vector. Further, a text-related feature may be learned from the image encoder by using the learned query vector, to become a bridge between the image encoder and the language model.

In an application stage of the Q-Former module, the first sample image is inputted to the image encoder. The image encoder performs image encoding on the first sample image, to output an image feature vector. The image feature vector is inputted to the first branch of the Q-Former module. Another input of the first branch of the Q-Former module is a query vector learned in the training stage. Further, the first branch obtains a target feature vector by using the image feature vector and the learned query vector. The target feature vector is outputted to the language model, to obtain a sample image text. In other embodiments of this application, the target feature vector may alternatively be directly outputted to the second branch, to obtain a sample image text.

The prompt augmentation module is configured to perform text supplementation based on the sample image text outputted by the caption module, to obtain a first sample text. For example, text augmentation is performed on the sample image text according to semantic information of the sample image text, to obtain an augmented sample text. Normalization is performed on the augmented sample text and the sample image text, to obtain a first sample text prompt-r.

The reverse diffusion module with a robustness constraint includes a reverse module and a robustness constraint module. The reverse module is shown in FIG. 15 to FIG. 17, and details are not described herein again. The robustness constraint module is configured to ensure that the generated image has sufficient robustness for perturbation of the prompt. It is considered that an intersection set of noise images brought by different Ns and the denoised original image is introduced at the same noise intensity. For example, during denoising, noise sample images generated at steps N/2, N/4, and N are randomly obtained, and the noise sample images generated at steps N/2, N/4, and N are added pixel by pixel, to add sufficient perturbation to the image generated at step N, for example:

$$M + α N$$

where M is an image of step N/2 and step N/4, N is an image of step N, and a takes a value of 1.5.

An image obtained after the pixel-by-pixel addition is used as the second sample image.

To ensure that a prompt and an image that are obtained after text-to-image generation and image-to-text generation are consistent semantically, an image loss and a text loss are constructed.

eₓ and e_{y} are obtained through an embedding tensor that is obtained by processing the first sample image and the second sample image through the text feature extraction module in the reverse diffusion module. Therefore, the image loss is:

$${l}_{pcls} = \frac{{e}_{x} \cdot {e}_{y}}{‖ {e}_{x} ‖ ‖ {e}_{y} ‖}$$

Term frequency (TF) vectors respectively corresponding to the initial sample text and the first sample text are obtained, for example:

$$A = ( {a}_{1} , {a}_{2} , … , {a}_{i} , … {a}_{n} )$$

$$B = ( {b}_{1} , {b}_{2} , … , {b}_{i} , … {b}_{n} )$$

A Euclidean distance between the TF vectors is calculated as:

$$distance = \sqrt[2]{{\sum }_{i = 1}^{n} {( {a}_{i} - {b}_{i} )}^{2}}$$

The text loss is:

$${l}_{icls} = \frac{1}{distance + 0.001}$$

A model parameter of the to-be-trained model is adjusted by using the image loss and the text loss, to obtain the image-text model.

In this embodiment of this application, after the image-text model is obtained through training, for an image-to-text task, an image may be parsed by using only the caption module in the image-text model to obtain a desired prompt; and for a text-to-image task, a text may be parsed by using the entire image-text model to parse a text to obtain a desired image.

According to the image processing method provided in this embodiment of this application, through the foregoing multi-constraint between a text and an image, it is ensured that after the model generates an image, a prompt re-parsed by the model can describe the image as accurately as possible, and after the model generates a text, an image re-parsed by the model can describe the text as accurately as possible.

Apparatus embodiments of this application are described herein, which may be configured for performing the image processing method in the foregoing embodiments of this application. For details not disclosed in the apparatus embodiments of this application, reference is made to the foregoing embodiments of the image processing method of this application.

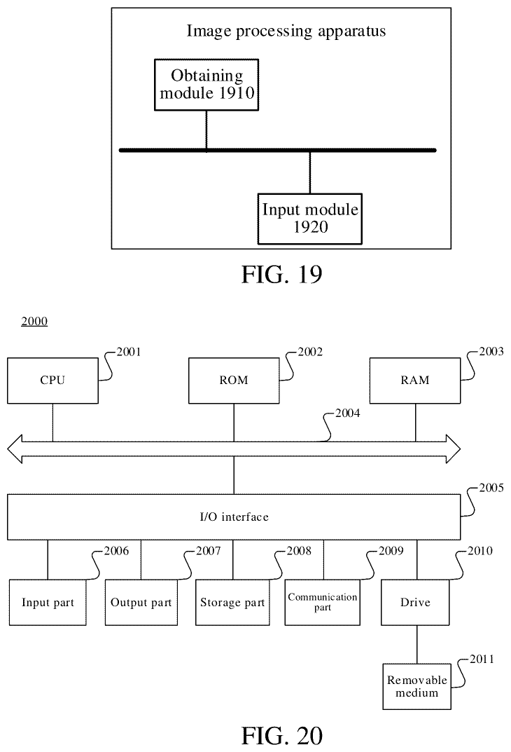

An embodiment of this application provides an image processing apparatus. As shown in FIG. 19, the apparatus includes:
an obtaining module 1910, configured to obtain a target image to be processed; and
an input module 1920, configured to input the target image to a pre-trained image-text model, a model loss of the image-text model including an image loss, and the image loss being constructed according to a first sample image and a second sample image that is obtained by converting a first sample text configured for describing the first sample image,
the obtaining module 1910 being further configured to obtain a target text configured for describing image content of the target image and generated by the image-text model.

In an embodiment of this application, based on the foregoing solution, the apparatus further includes a training module. The training module is configured to: obtain a to-be-trained model; obtain an initial sample text configured for describing image content, and generate, based on the to-be-trained model and according to the initial sample text, a first sample image configured for describing the initial sample text; generate the first sample text based on the to-be-trained model and according to the first sample image, and generate, according to the first sample text, a second sample image configured for describing the first sample text; construct the image loss according to a difference between the first sample image and the second sample image, and generate the model loss according to the image loss; and adjust a model parameter of the to-be-trained model according to the model loss, to obtain the image-text model.

In an embodiment of this application, based on the foregoing solution, the training module is further configured to: separately perform feature extraction on the first sample image and the second sample image, to obtain a first sample image feature of the first sample image and a second sample image feature of the second sample image; and construct the image loss according to a distance between the first sample image feature and the second sample image feature.

In an embodiment of this application, based on the foregoing solution, the training module is further configured to: construct a text loss according to a difference between the initial sample text and the first sample text; and generate the model loss according to the text loss and the image loss.

In an embodiment of this application, based on the foregoing solution, the training module is further configured to: obtain an initial sample text feature corresponding to a valid word or sentence having semantic information in the initial sample text, and a first sample text feature corresponding to the valid word or sentence in the first sample text; and construct the text loss according to a distance between the initial sample text feature and the first sample text feature.

In an embodiment of this application, based on the foregoing solution, the apparatus further includes a supplementary module. The supplementary module is configured to obtain a supplementary text supplementing the target text, and generate a to-be-processed text according to the supplementary text and the target text. The input module is further configured to input the to-be-processed text to the image-text model, to obtain an image configured for describing the to-be-processed text and generated by the image-text model.

In an embodiment of this application, based on the foregoing solution, the training module is further configured to: perform feature extraction on the initial sample text based on the to-be-trained model, to obtain an initial sample text vector; obtain a random noise-added sample image; and perform denoising on the random noise-added sample image based on the to-be-trained model and according to the initial sample text vector, to obtain the first sample image.

In an embodiment of this application, based on the foregoing solution, the training module is further configured to: perform image encoding on the first sample image based on the to-be-trained model, to obtain an image feature vector; obtain, based on the to-be-trained model, a target feature vector according to the image feature vector and a query vector that is learned in advance by using text information, the target feature vector being configured for representing image information related to the text information in the first sample image; generate a sample image text based on the to-be-trained model and according to the target feature vector; and generate the first sample text based on the to-be-trained model and according to the sample image text.

In an embodiment of this application, based on the foregoing solution, the training module is further configured to: perform text augmentation on the sample image text based on the to-be-trained model and according to semantic information of the sample image text, to obtain an augmented sample text; and perform normalization on the augmented sample text and the sample image text based on the to-be-trained model, to obtain the first sample text.

In an embodiment of this application, based on the foregoing solution, the training module is further configured to: perform feature extraction on the first sample text based on the to-be-trained model, to obtain a first sample text vector; perform successive denoising on the random noise-added sample image based on the to-be-trained model and according to the first sample text vector and a preset noise-sampling step quantity, to obtain a plurality of noise sample images, where a noise intensity corresponding to each time of denoising is the same; select at least two noise sample images from the plurality of noise sample images based on the to-be-trained model, the at least two noise sample images including a target noise sample image corresponding to the last time of denoising; and generate the second sample image based on the to-be-trained model and according to the at least two noise sample images.

In an embodiment of this application, based on the foregoing solution, the training module is further configured to: adding values of corresponding pixels of other noise sample images than the target noise sample image in the at least two noise sample images based on the to-be-trained model, to obtain an intermediate noise sample image; obtain, based on the to-be-trained model, a perturbation item set for the target noise sample image, and perform perturbation processing on the target noise sample image according to the perturbation item, to obtain a perturbed noise sample image; and generate the second sample image based on the to-be-trained model and according to the intermediate noise sample image and the perturbed noise sample image.

In an embodiment of this application, based on the foregoing solution, the training module is further configured to: after performing any time of denoising on the random noise-added sample image based on the to-be-trained model, obtain an obtained current noise sample image; predict a current noise value based on the to-be-trained model and according to the current noise sample image and the first sample text vector; and perform denoising based on the to-be-trained model and according to the current noise sample image, the first sample text vector, and the current noise value, to generate a next noise sample image, until a number of times of denoising reaches the preset noise-sampling step quantity, to obtain the plurality of noise sample images.

The apparatus provided in the foregoing embodiments and the method provided in the foregoing embodiments belong to the same idea. Specific manners in which the modules and the units perform operations have been described in detail in the method embodiments. Details are not described herein again.

The apparatus provided in the foregoing embodiment may be disposed in a terminal, or may be disposed in a server. Through the apparatus provided in this embodiment of this application, the target image to be processed is inputted to the image-text model. The model loss of the image-text model includes the image loss, where the image loss is constructed according to the first sample image and the second sample image that is obtained by converting the first sample text configured for describing the first sample image. The second sample image obtained through image-to-text generation and text-to-image generation can better reflect a consistency status of image content in a conversion process. Further, based on the image loss constructed based on the first sample image and the second sample image, the image-text model obtained through image loss training can improve a situation in which content information is lost in the conversion process, and ensure consistent image content. Further, the target text generated by the image-text model can describe the target image as much as possible, thereby ensuring accuracy of the target text.

An embodiment of this application further provides an electronic device, including one or more processors, and a storage apparatus. The storage apparatus is configured to store one or more computer programs. The one or more computer programs, when executed by the one or more processors, cause the electronic device to implement the image processing method described above.

FIG. 20 is a schematic structural diagram of a computer system adapted to implement an electronic device according to an embodiment of this application.

A computer system 2000 of the electronic device shown in FIG. 20 is merely an example, and does not constitute any limitation on functions and use ranges of the embodiments of this application.

As shown in FIG. 20, the computer system 2000 includes a central processing unit (CPU) 2001, which may perform various suitable actions and processing based on a program stored in a read-only memory (ROM) 2002 or a program loaded from a storage part 2008 into a random access memory (RAM) 2003, for example, perform the method in the foregoing embodiments. The RAM 2003 further has various programs and data required for operating the system stored therein. The CPU 2001, the ROM 2002, and the RAM 2003 are connected to each other through a bus 2004. An input/output (I/O) interface 2005 is also connected to the bus 2004.

In some embodiments, the following components are connected to the I/O interface 2005: an input part 2006 including a keyboard, a mouse, and the like; an output part 2007 including a cathode ray tube (CRT), a liquid crystal display (LCD), a speaker, and the like; a storage part 2008 including hardware, and the like; and a communication part 2009 including a network interface card such as a local area network (LAN) card, a modem, and the like. The communication part 2009 performs communication processing by using a network such as the Internet. A drive 2010 is also connected to the I/O interface 2005 as required. A removable medium 2011 such as a magnetic disk, an optical disk, a magneto-optical disk, or a semiconductor memory is installed on the drive 2010 as required, so that a computer program read from the removable medium is installed into the storage part 2008 as required.

Particularly, according to the embodiments of this application, the process described by referring to the flowchart in the above may be implemented as a computer program. For example, an embodiment of this application includes a computer program product. The computer program product includes a computer program stored in a computer-readable medium. The computer program includes a computer program configured for performing the method shown in the flowchart. In such an embodiment, the computer program may be downloaded and installed through the communication part 2009 from the network, and/or installed from the removable medium 2011. When the computer program is executed by the CPU 2001, various functions defined in the system of this application are executed.

The computer-readable medium shown in this embodiment of this application may be a computer-readable signal medium or a computer-readable storage medium, or any combination of the two. The computer-readable storage medium may be, for example, an electric, magnetic, optical, electromagnetic, infrared, or semi-conductive system, apparatus, or device, or any combination of the above. More specific examples of the computer-readable storage media may include, but are not limited to an electrical connection having one or more wires, a portable computer disk, a hard disk, a random access memory (RAM), a read-only memory (ROM), an erasable programmable read only memory, a flash memory, fiber optics, a portable compact disc read-only memory (CD-ROM), an optical storage device, a magnetic storage device, or any appropriate combination of the above. In this application, a computer-readable signal medium may include a data signal in a baseband or propagated as a part of a carrier wave, where the data signal carries a computer-readable computer program. A data signal propagated in such a manner may be in a plurality of forms, including, but not limited to, an electromagnetic signal, an optical signal, or any suitable combination of the above. The computer-readable signal medium may alternatively be any computer-readable medium other than the computer-readable storage medium. The computer-readable medium may send, propagate, or transmit a program used by or in combination with an instruction execution system, apparatus or device. The computer program included in the computer-readable medium may be transmitted by using any suitable medium, including but not limited to: a wireless medium, a wired medium, and the like, or any suitable combination of the above.

The flowcharts and block diagrams in the accompanying drawings illustrate possible system architectures, functions, and operations that may be implemented by the apparatus, the method, and the computer program product according to various embodiments of this application. Each box in the flowcharts or the block diagrams may represent a module, a program segment, or a part of code. The module, the program segment, or the part of code includes one or more executable instructions configured for implementing specified logic functions. In some alternative implementations, the functions labeled in the box may alternatively occur in a sequence different from those labeled in the accompanying drawings. For example, two boxes shown in succession may be actually executed substantially in parallel, or sometimes the two boxes may be performed in a reverse sequence. This is determined according to a related function. Each box in the block diagrams or the flowcharts and combinations of boxes in the block diagrams or the flowcharts may be implemented by a dedicated hardware-based system that performs specified functions or operations, or may be implemented by a combination of dedicated hardware and a computer program.

A related unit or module described in the embodiments of this application may be implemented by using software, or may be implemented by using hardware, and the unit described may alternatively be arranged in a processor. Names of the units or modules do not constitute a limitation on the units or modules in a specific case.

Another aspect of this application further provides a computer-readable storage medium, having a computer program stored therein. The computer program, when executed by a processor, implements the image processing method described above. The computer-readable storage medium may be included in the electronic device described in the foregoing embodiments, or may exist alone without being installed into the electronic device.

Another aspect of this application further provides a computer program product. The computer program product includes a computer program. The computer program is stored in a computer-readable storage medium. A processor of an electronic device reads the computer program from the computer-readable storage medium and executes the computer program, causing the electronic device to perform the foregoing image processing method provided in the foregoing embodiments.

Although several modules or units of a device configured to perform operations are mentioned in the above detailed descriptions, such division is not mandatory. Actually, according to the implementations of this application, features and functions of two or more modules or units described above may be specifically implemented in one module or unit. On the contrary, the features and functions of one module or unit described above may be further divided and embodied by a plurality of modules or units.

A person skilled in the art may easily figure out another implementation of this application after considering the specification and practicing the implementations disclosed herein. This application is intended to cover any variations, uses, or adaptive changes of this application. These variations, uses, or adaptive changes follow the general principles of this application and include common general knowledge or common technical means in the art, which are not disclosed in this application.

The foregoing descriptions are merely exemplary embodiments of this application, and are not intended to limit the implementations of this application. A person of ordinary skill in the art may conveniently make variations or modifications according to the main idea and spirit of this application. Therefore, the protection scope of this application shall be subject to the protection scope of the claims.

What is claimed is:

1. An image processing method, comprising:
obtaining a target image;
inputting the target image to a pre-trained image-text model, wherein a model loss of the image-text model comprises an image loss, the image loss being constructed according to a first sample image and a second sample image that is obtained by converting a first sample text configured for describing the first sample image; and
obtaining a target text configured for describing the target image and generated by the image-text model.

2. The method according to claim 1, wherein before inputting the target image to the pre-trained image-text model, the method further comprises:
obtaining a to-be-trained model;
obtaining an initial sample text configured for describing image content;
generating, based on the to-be-trained model and according to the initial sample text, the first sample image configured for describing the initial sample text;
generating, based on the to-be-trained model and according to the first sample image, the first sample text;
generating, according to the first sample text, the second sample image configured for describing the first sample text;
constructing the image loss according to a difference between the first sample image and the second sample image;
generating the model loss according to the image loss; and
adjusting a model parameter of the to-be-trained model according to the model loss for obtaining the image-text model.

3. The method according to claim 2, wherein constructing the image loss according to the difference between the first sample image and the second sample image comprises:
respectively performing feature extraction on the first sample image and the second sample image for obtaining a first sample image feature of the first sample image and a second sample image feature of the second sample image; and
constructing the image loss according to a distance between the first sample image feature and the second sample image feature.

4. The method according to claim 2, wherein generating the model loss according to the image loss comprises:
constructing a text loss according to a difference between the initial sample text and the first sample text; and
generating the model loss according to the text loss and the image loss.

5. The method according to claim 4, wherein constructing the text loss according to the difference between the initial sample text and the first sample text comprises:
obtaining an initial sample text feature corresponding to a valid word or sentence having semantic information in the initial sample text, and a first sample text feature corresponding to a valid word or sentence in the first sample text; and
constructing the text loss according to a distance between the initial sample text feature and the first sample text feature.

6. The method according to claim 1, wherein after obtaining the target text configured for describing the target image and generated by the image-text model, the method further comprises:
obtaining a supplementary text supplementing the target text;
generating a to-be-processed text according to the supplementary text and the target text; and
inputting the to-be-processed text to the image-text model for obtaining an image configured for describing the to-be-processed text and generated by the image-text model.

7. The method according to claim 2, wherein generating, based on the to-be-trained model and according to the initial sample text, the first sample image configured for describing the initial sample text comprises:
performing feature extraction on the initial sample text based on the to-be-trained model, to obtain an initial sample text vector;
obtaining a random noise-added sample image; and
performing, based on the to-be-trained model and according to the initial sample text vector, denoising on the random noise-added sample image for obtaining the first sample image.

8. The method according to claim 2, wherein generating, based on the to-be-trained model and according to the first sample image, the first sample text comprises:
performing image encoding on the first sample image based on the to-be-trained model, to obtain an image feature vector;
obtaining, based on the to-be-trained model, a target feature vector according to the image feature vector and a query vector, the query vector being learned in advance from text information, the target feature vector being configured for representing image information related to the text information in the first sample image;
generating a sample image text based on the to-be-trained model and according to the target feature vector; and
generating the first sample text based on the to-be-trained model and according to the sample image text.

9. The method according to claim 8, wherein generating, based on the to-be-trained model and according to the first sample image, the first sample text comprises:
performing, based on the to-be-trained model and according to semantic information of the sample image text, text augmentation on the sample image text for obtaining an augmented sample text; and
performing, based on the to-be-trained model, normalization on the augmented sample text and the sample image text for obtaining the first sample text.

10. The method according to claim 2, wherein generating, according to the first sample text, the second sample image configured for describing the first sample text comprises:
performing, based on the to-be-trained model, feature extraction on the first sample text for obtaining a first sample text vector;
performing, based on the to-be-trained model and according to the first sample text vector and a preset noise-sampling step quantity, successive denoising on a random noise-added sample image for obtaining a plurality of noise sample images, a noise intensity corresponding to each denoising being the same;
selecting, based on the to-be-trained model, at least two noise sample images from the plurality of noise sample images, the at least two noise sample images comprising a target noise sample image corresponding to a last time of denoising; and
generating, based on the to-be-trained model and according to the at least two noise sample images, the second sample image.

11. The method according to claim 10, wherein generating, based on the to-be-trained model and according to the at least two noise sample images, the second sample image comprises:
adding, based on the to-be-trained model, values of corresponding pixels of noise sample images other than the target noise sample image in the at least two noise sample images for obtaining an intermediate noise sample image;
obtaining, based on the to-be-trained model, a perturbation item set for the target noise sample image;
performing, according to the perturbation item, perturbation processing on the target noise sample image for obtaining a perturbed noise sample image; and
generating, based on the to-be-trained model and according to the intermediate noise sample image and the perturbed noise sample image, the second sample image.

12. The method according to claim 10, wherein performing, based on the to-be-trained model and according to the first sample text vector and the preset noise-sampling step quantity, successive denoising on the random noise-added sample image for obtaining the plurality of noise sample images, the noise intensity corresponding to each denoising being the same comprises:
obtaining, based on the to-be-trained model, an obtained current noise sample image after performing a time of denoising on the random noise-added sample image;
predicting, based on the to-be-trained model and according to the current noise sample image and the first sample text vector, a current noise value; and
performing, based on the to-be-trained model and according to the current noise sample image and the current noise value, denoising to generate a next noise sample image until a number of times of denoising reaching the preset noise-sampling step quantity, for obtaining the plurality of noise sample images.

13. An image processing apparatus, comprising a memory for storing instructions and a processor for executing the instructions, wherein the processor is configured to:
obtain a target image;
input the target image to a pre-trained image-text model, wherein a model loss of the image-text model comprises an image loss, the image loss being constructed according to a first sample image and a second sample image that is obtained by converting a first sample text configured for describing the first sample image; and
obtain a target text configured for describing the target image and generated by the image-text model.

14. The image processing apparatus according to claim 13, wherein before the processor is configured to input the target image to the pre-trained image-text model, is further configured to:
obtain a to-be-trained model;
obtain an initial sample text configured for describing image content;
generate, based on the to-be-trained model and according to the initial sample text, the first sample image configured for describing the initial sample text;
generate, based on the to-be-trained model and according to the first sample image, the first sample text;
generate, according to the first sample text, the second sample image configured for describing the first sample text;
construct the image loss according to a difference between the first sample image and the second sample image;
generate the model loss according to the image loss; and
adjust a model parameter of the to-be-trained model according to the model loss for obtaining the image-text model.

15. The image processing apparatus according to claim 14, wherein when the processor is configured to construct the image loss according to the difference between the first sample image and the second sample image, is further configured to:
respectively perform feature extraction on the first sample image and the second sample image for obtaining a first sample image feature of the first sample image and a second sample image feature of the second sample image; and
construct the image loss according to a distance between the first sample image feature and the second sample image feature.

16. The image processing apparatus according to claim 14, wherein when the processor is configured to generate the model loss according to the image loss, is further configured to:
construct a text loss according to a difference between the initial sample text and the first sample text; and
generate the model loss according to the text loss and the image loss.

17. The image processing apparatus according to claim 16, wherein when the processor is configured to construct a text loss according to the difference between the initial sample text and the first sample text, is further configured to:
obtain an initial sample text feature corresponding to a valid word or sentence having semantic information in the initial sample text, and a first sample text feature corresponding to a valid word or sentence in the first sample text; and
construct the text loss according to a distance between the initial sample text feature and the first sample text feature.

18. The image processing apparatus according to claim 13, wherein when the processor is configured to obtain the target text configured for describing the target image and generated by the image-text model, is further configured to:
obtain a supplementary text supplementing the target text;
generate a to-be-processed text according to the supplementary text and the target text; and
input the to-be-processed text to the image-text model for obtaining an image configured for describing the to-be-processed text and generated by the image-text model.

19. The image processing apparatus according to claim 14, wherein when the processor is configured to generate, based on the to-be-trained model and according to the initial sample text, the first sample image configured for describing the initial sample text, is further configured to:
perform feature extraction on the initial sample text based on the to-be-trained model, to obtain an initial sample text vector;
obtain a random noise-added sample image; and
perform, based on the to-be-trained model and according to the initial sample text vector, denoising on the random noise-added sample image for obtaining the first sample image.

20. A non-transitory computer-readable storage medium, storing a plurality of instructions adapted to be loaded by a processor to perform the steps comprising:
obtaining a target image;
inputting the target image to a pre-trained image-text model, wherein a model loss of the image-text model comprises an image loss, the image loss being constructed according to a first sample image and a second sample image that is obtained by converting a first sample text configured for describing the first sample image; and
obtaining a target text configured for describing the target image and generated by the image-text model.
